(19) United States
(12) Patent Application Publication
(10) Pub. No.: US 2014/0242824 A1
(43) Pub. Date: Aug. 28, 2014

(54) TERMINAL AND ELECTRICAL CONNECTOR WITH SAME

(71) Applicants: Margaret Karadimas, Lisle, IL (US); Arvind Patel, Naperville, IL (US)

(72) Inventors: Margaret Karadimas, Lisle, IL (US); Arvind Patel, Naperville, IL (US)

(73) Assignee: Molex Incorporated, Lisle, IL (US)

(21) Appl. No.: 14/233,449

(22) PCT Filed: Jul. 18, 2012
(86) PCT No.: PCT/US2012/047119

§ 371 Date: May 5, 2014

Related U.S. Application Data
(60) Provisional application No. 61/509,367, filed on Jul. 19, 2011.

(51) Int. Cl. H01R 13/53

(52) U.S. Cl. CPC H01R 13/53
USPC 439/181

(57) ABSTRACT

A connector is provided that includes a female terminal with sacrificial portion. The terminal is configured to minimize arcing between a mating male terminal and an intended contact portion of the female terminal. The female terminal is configured such that arcs between the male terminal and the female terminal occur such that the sacrificial portion of the female terminal experiences any arcing while the intended contact portion remains suitable for reliably engaging the male terminal.

### RELATED APPLICATIONS

This application claims priority to U.S. Provisional Appln. No. 61/509,367, filed Jul. 19, 2011, which is incorporated herein by reference in its entirety.

### FIELD OF THE INVENTION

This invention relates generally to the art of electrical connectors, and, more particularly, to a female or socket terminal for an electrical connector.

### BACKGROUND OF THE INVENTION

Mating electrical connectors typically employ pairs of inter-engaging pin and socket terminals for interconnecting a plurality of circuits or wires through the mated connectors. The pin and socket terminals are often called male and female terminals.

One type of female terminal includes a generally rectangular socket or receptacle at its mating end for receiving a generally rectangular pin or male terminal therein. The mating end is formed by an elongate body defining top and bottom walls and spaced apart opposing sidewalls, thereby defining a passageway for receiving the male terminal. Such terminals are conventionally stamped and formed from sheet material and the top and bottom walls may have open seams or slits, whereby the opposing sidewalls can flex transversely to the longitudinal axis of the terminal to enlarge the passageway as the male terminal is inserted therein.

Many applications require that connectors equipped with these types of terminals be plugged or mated together while electrical power is present at the terminals. Such connectors are known as hot pluggable connectors. During mating, and primarily unmating of the terminals in these hot pluggable connectors, electrical arcs are created by electrical current passing through the terminals as the terminals are mated or unmated. The terminals may become damaged by such arcing. Furthermore, non-conductive or poorly conducting residues, such as carbon and the like, may build up on the electrical contacts in the terminals due to the arcing. Such residues can interfere with the quality of the electrical contact between the terminals in a subsequent connection.

Some attempts to provide protection against arc discharging in the prior art include providing separate sequential terminals, or providing forward or lateral extensions on the terminals for sequential engagement of the terminals. While effective in reducing the negative effects of arcing, such terminals were larger than necessary due to the extra space required by these forward or lateral extensions. In some cases, these modified terminals were also more complicated to manufacture. Thus certain individuals would appreciate an improved terminal and/or connector system using the same.

### SUMMARY OF THE INVENTION

In the exemplary embodiment, a female terminal has a mating end to receive a male pin with spaced apart flat surfaces and a circuit connecting end for connection to a wire, or the like. The elongate body of the female terminal defines a terminal-receiving passageway with two spaced apart sidewalls extending lengthwise along the passageway. One or more primary terminal contacts are disposed inwardly from at least one of the sidewalls into the terminal-receiving passageway to provide the electrical contact between the female and male terminals when the male terminal is fully inserted into the female terminal. One or more arc discharging contacts are formed forwardly of the primary contacts to engage the male pin first to accept the arcing that can occur between electrical connections that are mated while one terminal is coupled to a power source (e.g., hot pluggable).

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures in which like reference numerals identify like elements, and in which:

FIG. 1 is a top perspective view of the electrical connector system showing the plug connector and the receptacle connector mated together.

FIG. 2 is a top perspective view of the electrical connector with the plug connector removed from the receptacle connector.

FIG. 3 is an exploded view of the connector system;

FIG. 4 is a top perspective view of a female terminal lead looking from the termination end of the female terminal.

FIG. 5 is a top perspective view of the female terminal lead looking from the mating end of the female terminal.

FIG. 6 is an enlarged top perspective of the female terminal shown in FIG. 5.

FIG. 7a is a perspective view of the female terminal looking at the top of the terminal.

FIG. 7b is a perspective view similar to FIG. 7a looking at the bottom of the terminal.

FIG. 8 is a sectional view of the female terminal of FIG. 2 with a portion of the insulative housing cavity surrounding the female terminal.

FIG. 9 is a sectional view of the female terminal of FIG. 7a showing the arc discharging contacts.

FIG. 10 is a sectional view of the female terminal of FIG. 7a showing the primary contacts.

FIG.11 is a sectional view of the female terminal similar to FIG. 9 with the male pin partially inserted.

FIG. 12 is a sectional view of the female terminal similar to FIG. 9 with the male pin partially inserted.

FIG. 13 is a sectional view of the female terminal similar to FIG. 12 with the male pin further inserted.

FIG. 14 is a sectional view of the female terminal similar to FIG. 13 with the male pin fully inserted.

FIG. 15 is a sectional view of the female terminal similar to FIG. 11 with the male pin fully inserted.

### DETAILED DESCRIPTION OF THE INVENTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

In certain embodiments the depicted embodiments can provide an improved female electrical terminal that helps control discharging arcs between mating terminals as connectors are hot plugged together. Certain embodiments allow one or more sacrificial electrical contacts in a female terminal configured to engage the male terminal to discharge any arcs before the male terminal engages the primary electrical contacts. This can allow the provision of a female terminal with arc discharge protection for the primary contacts which is compact and inexpensive to manufacture.

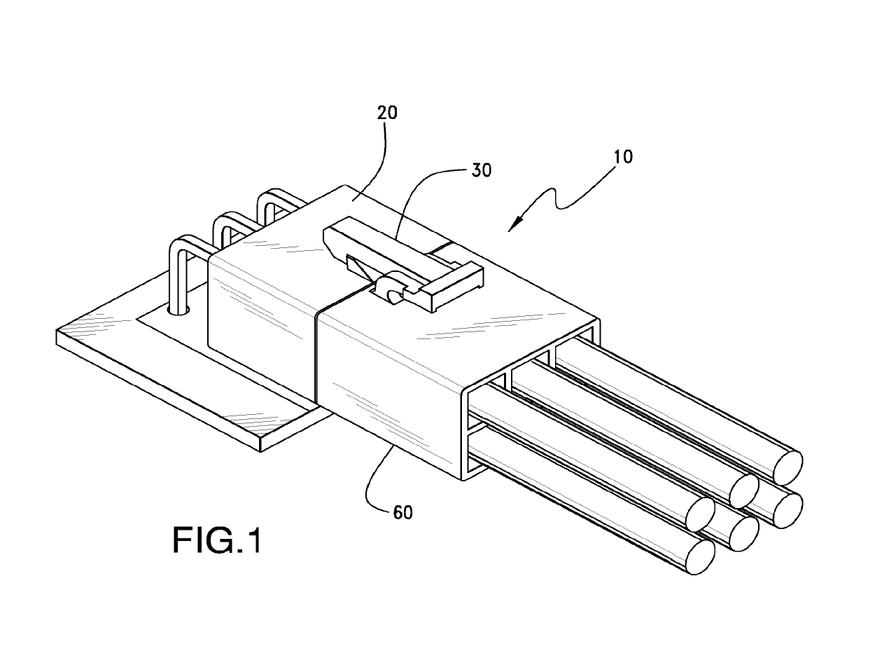

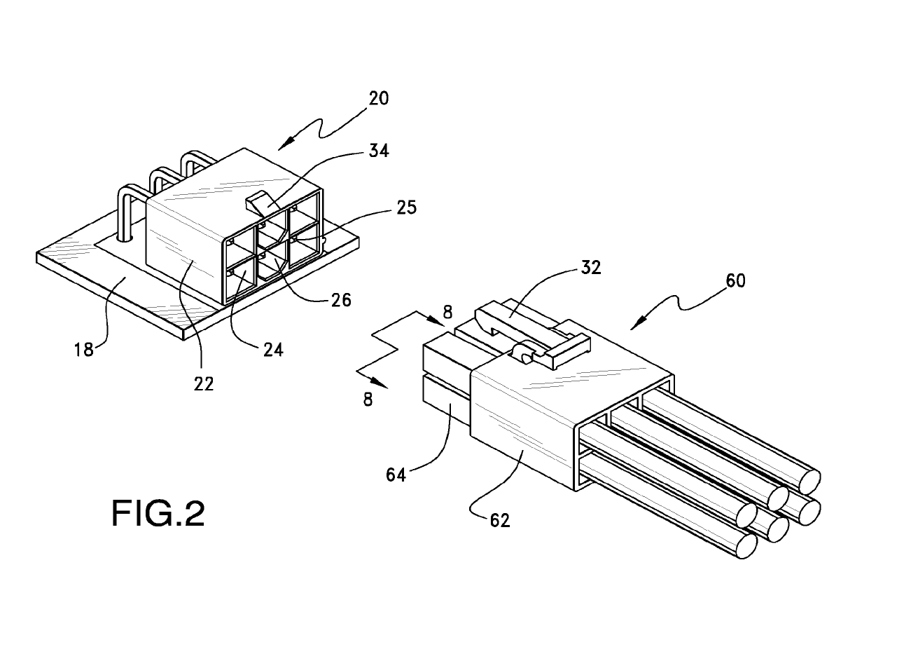

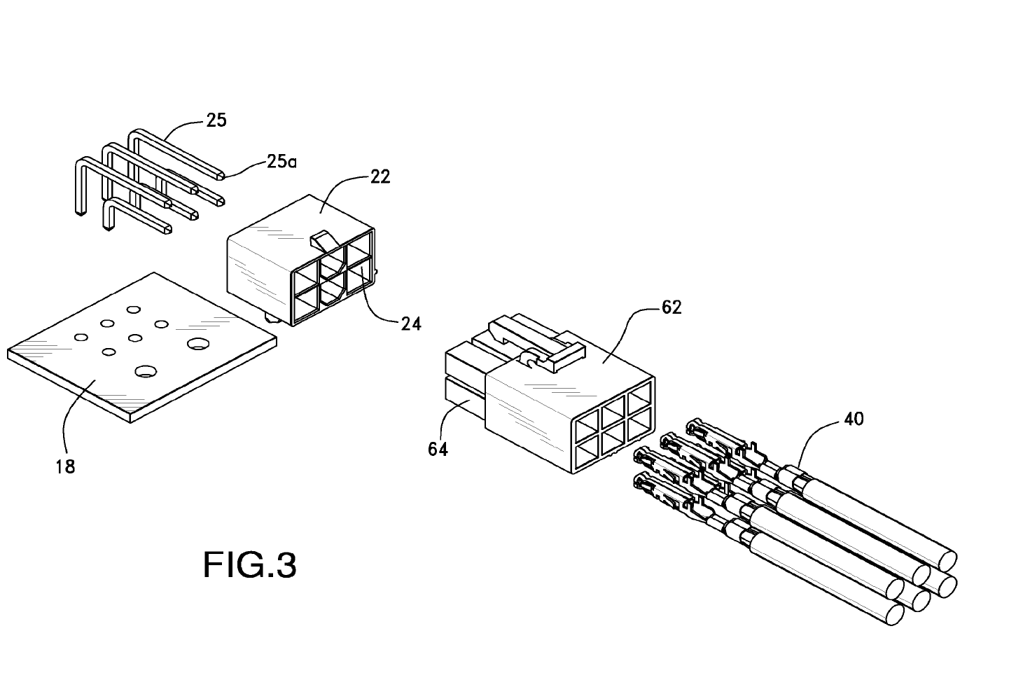

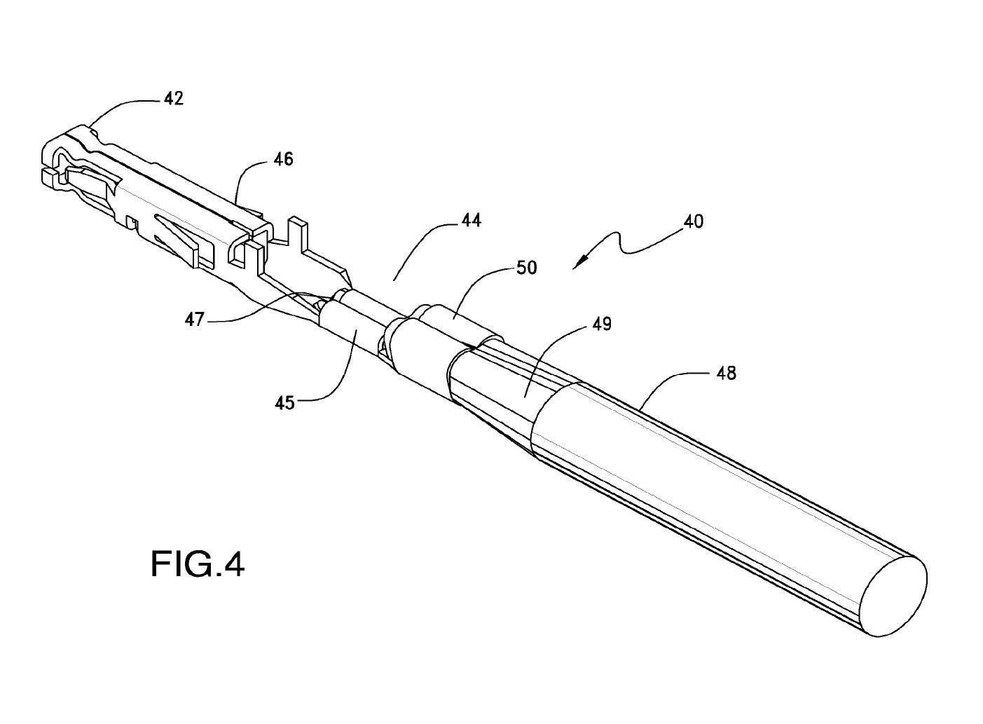

Referring to the drawings in greater detail and first to FIGS. 1 to 3, the invention is incorporated in a power connector or the like generally designated 10, having a plug 60 and receptacle 20. The receptacle connector 20 is shown as a right angle circuit board connector but may be of any type including a wire harness connector. The receptacle connector 20 includes a plurality of male terminal pins 24, retained in an insulative housing 22 and typically mounted to a printed circuit board designated 18. The plug connector 60 includes corresponding female terminals 40 retained in an insulative housing 62 for mating with the receptacle insulative housing 22. The housings include a selectively engagable locking structure 30 used to retain the plug and receptacle together. The locking structure has a resilient latching portion 32 typically formed on the plug housing 62 and a lock portion 34 generally formed on the receptacle housing 22.

Each male terminal and female terminal has a portion of their corresponding insulative housing 24, 64 generally surrounding each respective terminal. These portions of the housing can provide an insulative enclosure that encloses at least a portion of each terminal. These portions of the housing may include a keying feature 26 that allows selective housing configurations to engage only the correct mating connector halves.

The female terminal 40 includes a mating portion or end, generally designated 42, a terminating portion or end, generally designated 44, and an intermediate securing portion or section, generally designated 46.

The female terminal 40 is stamped and formed from sheet metal material, and the terminating end 44 is constructed for crimping onto an electrical wire, generally designated 48. More particularly, the terminating end of the female terminal includes a rear pair of crimp arms 50 for crimping onto the outer insulation 49 of the electrical wire 48, along with a forward pair of crimp arms 45 for crimping onto a stripped or exposed conductor 47 or conductive core of wire 48.

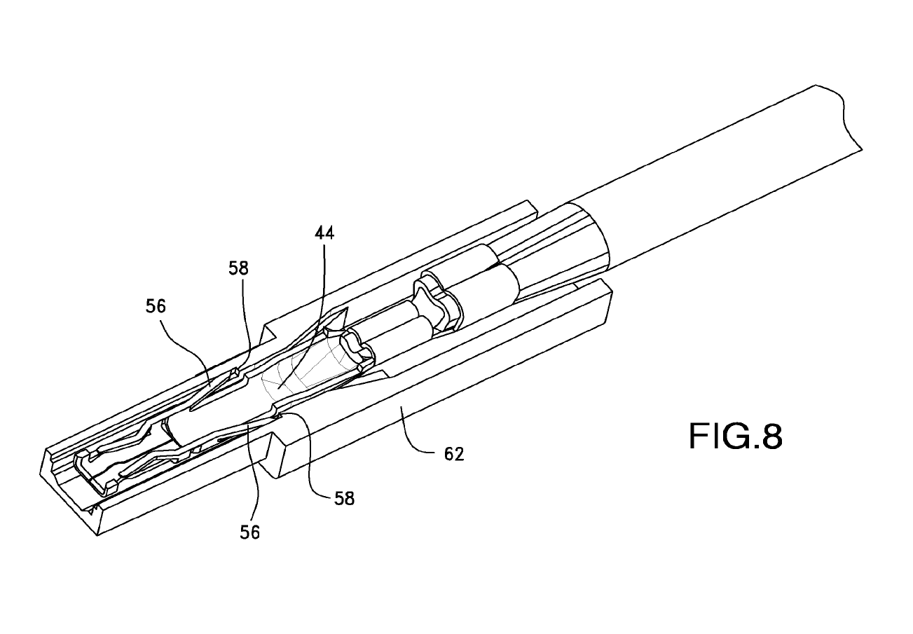

Intermediate portion 44 of the female terminal 40 includes a pair of stamped and formed locking arms or tabs 56 which project outwardly from opposite sides of the terminal. These locking arms are cantilevered rearwardly and resiliently snap behind locking shoulders 58 in FIG. 8 on the inside of a connector housing, generally designated 62, to prevent the terminal from backing out of housing 62 after the terminal is inserted therein. The intermediate portion 44 may also include a projection 70 extending downwardly that engage stop shoulders within the connector housing 62 to define the fully inserted position of the female terminal within the housing, and to also stabilize the terminal within the housing against torsional or rotational movement about the longitudinal axis of the terminal.

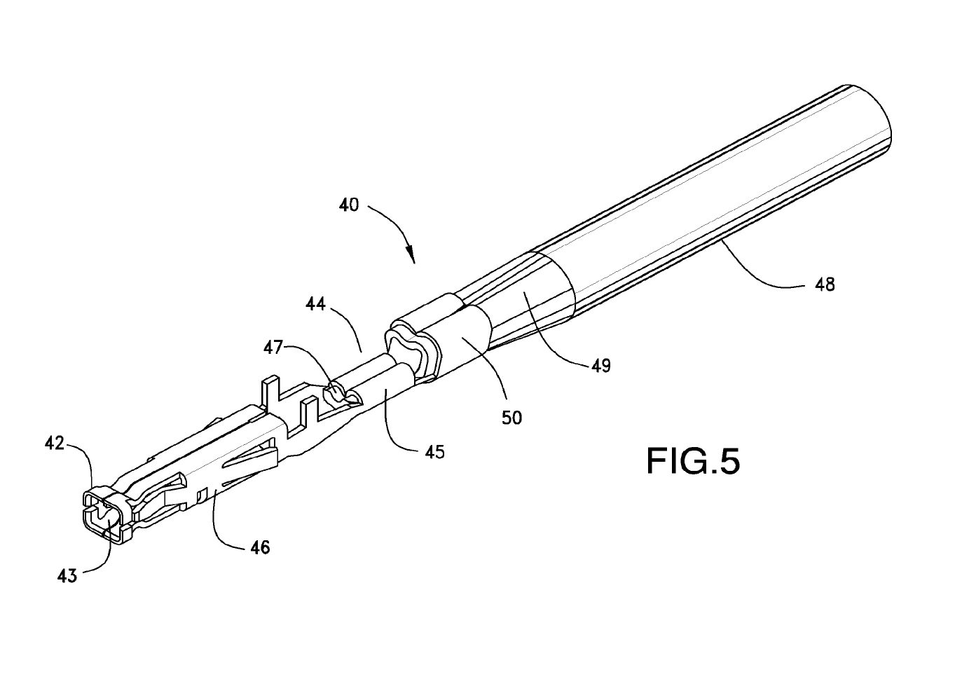

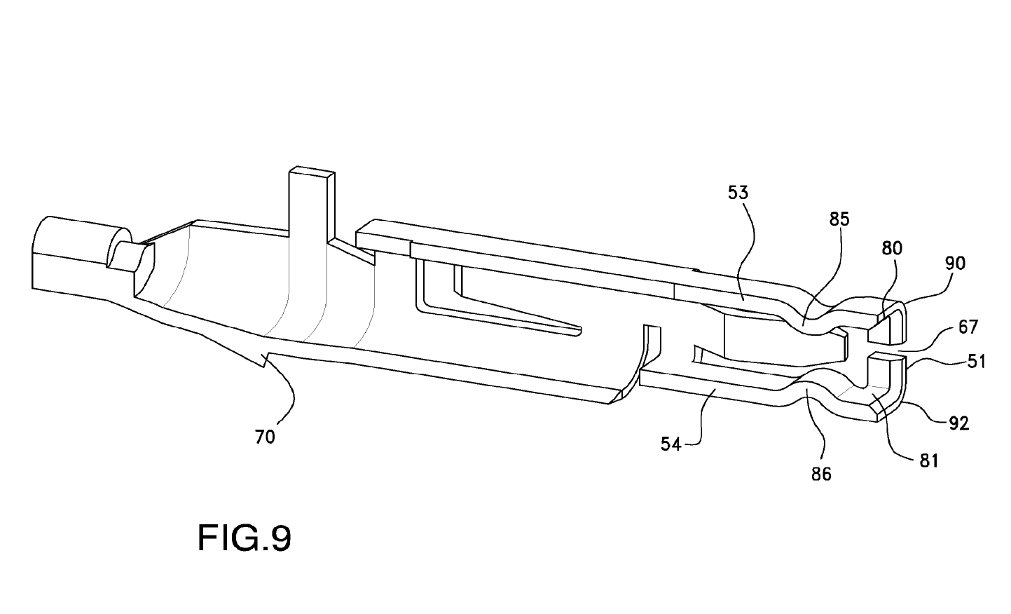

With reference to FIG. 5, the mating end or portion 42 of the female terminal 40 includes a passageway 43 adapted to receive a male terminal or pin 25, as will be presented in more detail with respect to FIGS. 9-13, below. Male pin 25 preferably has at least two sets of two spaced apart and generally parallel flat sides 35 and 36, such as are provided by a pin with a square or rectangular cross section. Male pin 25 may also have a tapered or wedge-shaped end 25a for ease of insertion of the male pin into the passageway 43 of the female terminal 40.

The mating end 42 of the female terminal is formed of a pair of channels 51 and 52 that are of generally U-shaped cross section, and that are separated by open seams or slits 53 and 54 such that the ends of the legs of the U-shaped channels are spaced adjacently to, but apart from each other. Channels 51 and 52 thereby define a generally rectangular or square shaped passageway 43 therebetween for receiving the male terminal 25 therein.

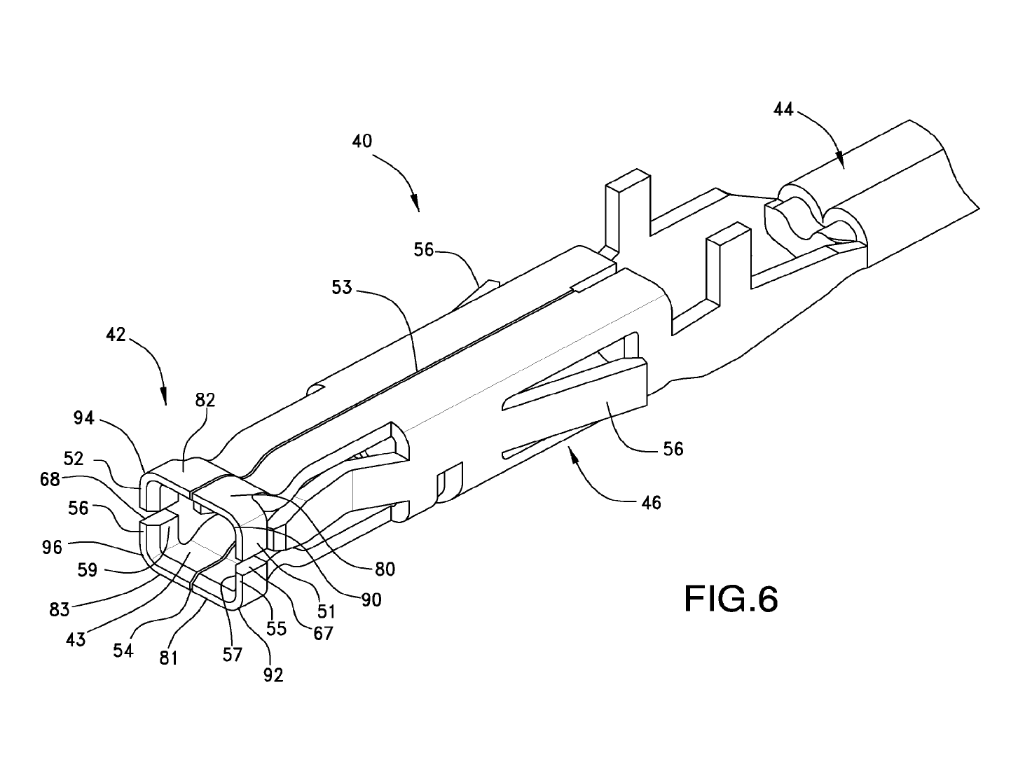

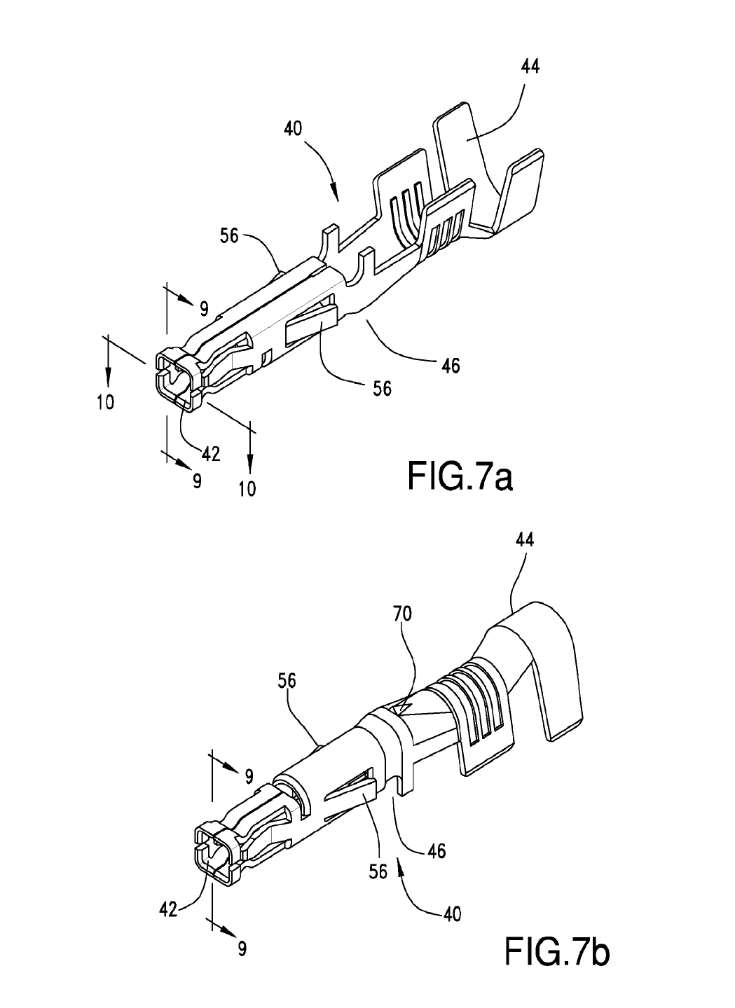

The bottoms of the U-shaped channels 55 and 56 are generally flat to define a first pair of opposing sidewalls 57 and 59 in the passageway 43, as can best be seen in FIGS. 6-9. Each of U-shaped channels 55 and 56 has opposing channel sidewalls 80, 81 and 82, 83 respectively. Each opposing channel sidewall further includes a second seam or slit 67 and 68 defining two deflection portions 90, 92 and 94, 96 near the open end of the passageway 43 at the mating portion 42 of female terminal 40.

In accordance with one aspect of the present invention, at least one arc discharging contact 85 or 86 is disposed in channel sidewall 80 or 81, respectively, near the open end of the passageway 43. Preferably, arc discharging contacts 85 and 86 are provided in both of the channel sidewalls 80 and 81 of each U-shaped channel 55 and 56. As best seen in FIG. 9, one of the arc discharging contacts 85 may be integrally formed into the channel sidewall 80 of channel 51 during the metal stamping and forming processes used to create the female terminal 40.

In the form illustrated in FIG. 9, arc discharging contact 85 has a circular cross-section of metal that is curved inwardly into the passageway 43 defined between channels 51 and 52. This generally curved or circular shape provides the arc discharging contacts 85 and 86 with resiliency to flex against the sides of the male terminal 25 when the male terminal 25 is received in the female terminal 40.

As used herein, the expressions “sacrificial contacts” and “arc discharging contacts” are used interchangeably and are intended to mean the same thing, namely a contact that discharges an arc between two interconnecting terminals. The electrically conductive quality of such contacts is “sacrificed” since arcs leave deposits of non-conductive or poorly conducting residues on the contacts. Nevertheless, these sacrificial contacts do conduct current and will act as additional contact points if the effects of the arc creating non-conductive residue are not extreme.

Enlarged primary contacts 60 and 62 are provided in the mating end 42 of the female terminal 40 to engage and to provide the primary electrical contact between the mating pin 25 and the female terminal 40. These enlarged contacts 60 and 62 are formed in the respective first pair of opposing sidewalls 57 and 59 in the bottoms of the U-shaped channels 55 and 56 by metal forming and stamping techniques that are known in the art.

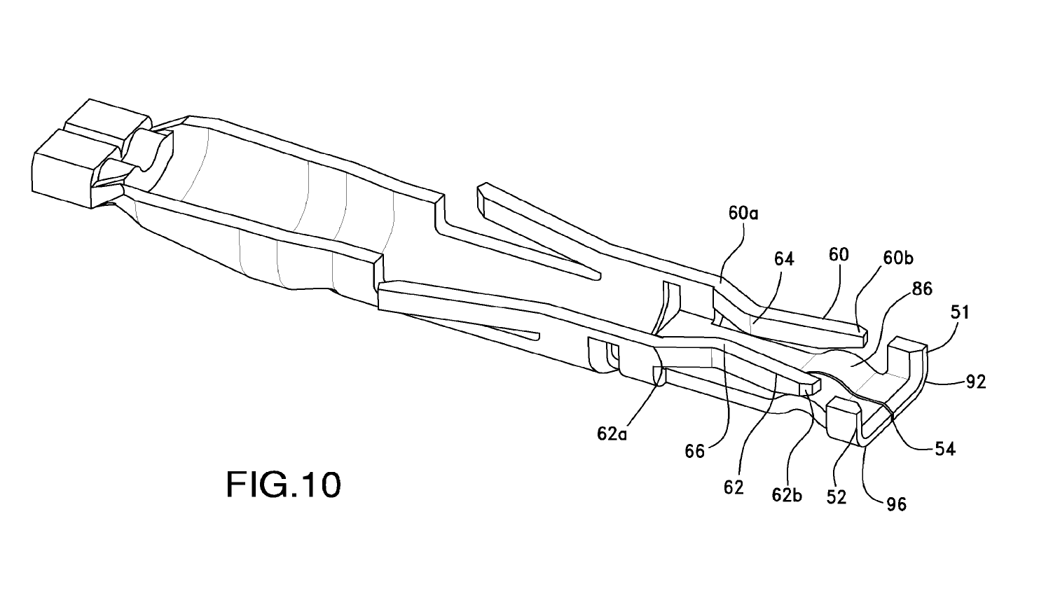

As shown in FIG. 10, the primary contacts 60 and 62 are preferably elongated and formed in the longitudinal direction of the female terminal. Each primary contact 60 and 62 includes a cantilever beam having a base portion 60a and 62a depending from the bottom sidewall of each respective U-shaped channels. Each primary contact has a contact area 64 and 66 respectively provided on the cantilever beam of the primary contacts 60 and 62 of the female terminal 40. The beam portion extends toward the mating end of the female terminal 40 and projects into the passageway 43 to provide an area of contact with the male pin 25.

As shown in FIG. 6 the U-shaped channels 55 and 56 form a first pair of opposing sidewalls 57 and 59 and channel sidewalls 80, 81 and 82, 83 formed on respective U-shaped channels form a second pair of opposing sidewalls adjacent the first pair of sidewalls generally creating a square or rectangular shaped passageway 43 in the female terminal 40. Sidewalls 57 and 59 have primary contacts 60 and 62 respectively formed therein and channel sidewalls 80, 81 and 82, 83 have arc discharging contacts 85 and 86 respectively formed therein. Arc discharging contacts 85 and 86 formed on the channel sidewalls are positioned closer to the mating end of the female terminal 40 than the primary contacts 60 and 62 formed on the sidewalls of the U-shaped channels.

Also as shown in FIG. 6 the U-shaped sidewalls 55 and 56 form two of the passageway sidewalls. The remaining adjacent two sidewalls of the square or rectangular shaped passageway 43 are formed by each pair of opposing channel sidewalls 80, 81 and 82, 83. In this case, there are four portions that make up these opposing adjacent sidewalls. Each of these portions has arc discharging contacts 85 and 86 formed therein. As best shown in FIG. 6 the arc discharging contacts are formed in the same relative position on the channel sidewalls but may be in a staggered relationship but in any event all are positioned forward of the primary contacts.

FIGS. 9-15, sequentially illustrate the insertion of the male terminal 25, which is in this embodiment is in the form of a generally rectangular pin, into the mating portion 43 of the female terminal 40.

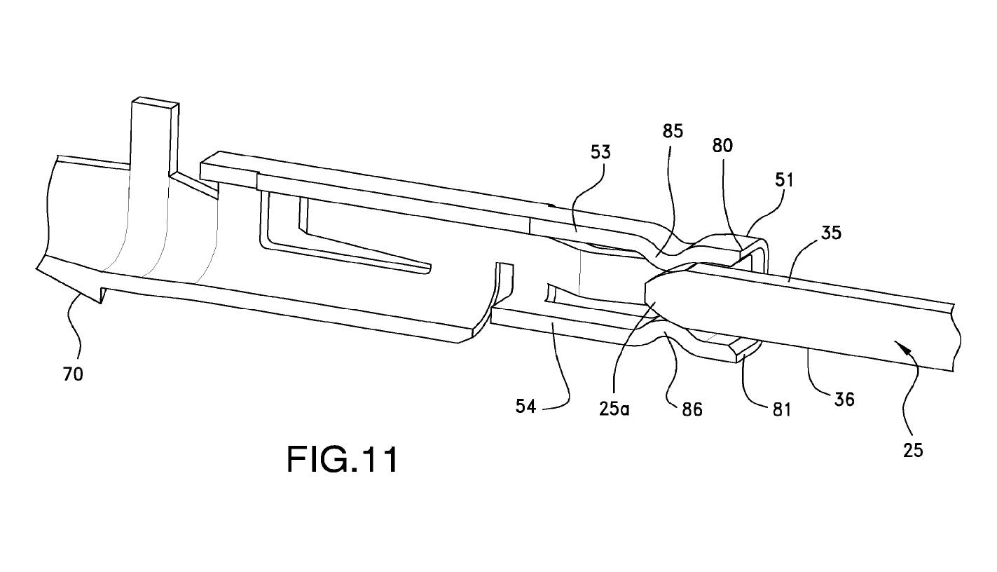

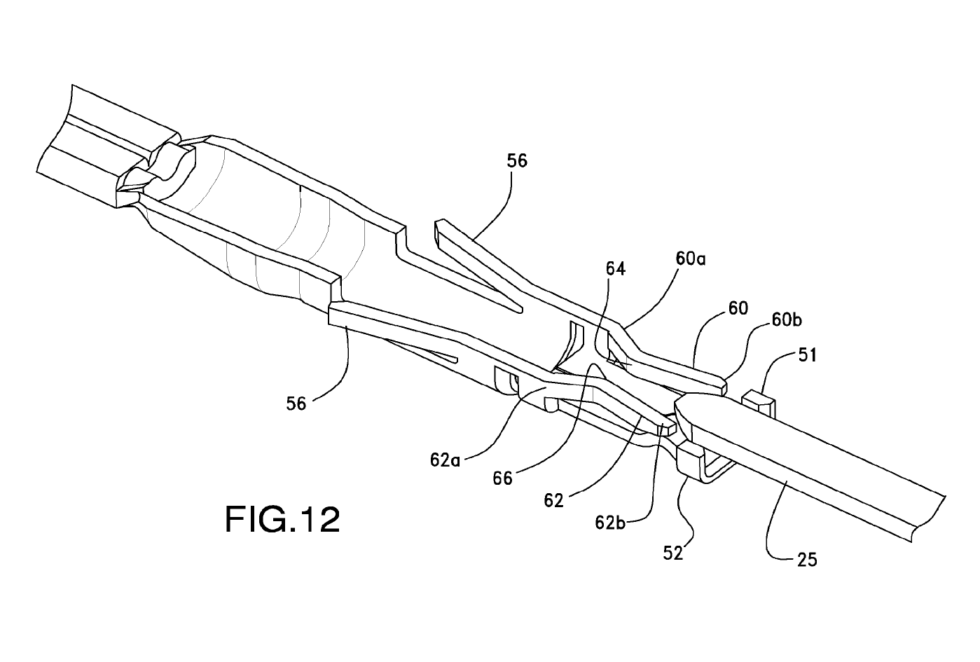

FIGS. 9 and 10 illustrate the condition in which no male terminal 25 is in the passageway 43. FIGS. 11 and 12 illustrates the condition in which male terminal 25 is beginning to be inserted into the passageway 43. The tapered end 25a of terminal 25 just contacts the arc discharging contacts 85 and 86. Each arc discharging contact formed on the opposing channel sidewalls may contact the male pin at four different individual points to compensate for any misalignment between the male pin 25 and female terminal 40. At this time, if there is a voltage potential between the male pins 25 and the female terminals 40, as may be the case with hot pluggable connectors, an arc discharge may occur between male terminal 25 and one or all of the arc discharge contacts 85 and 86 formed on the opposing channel sidewalls.

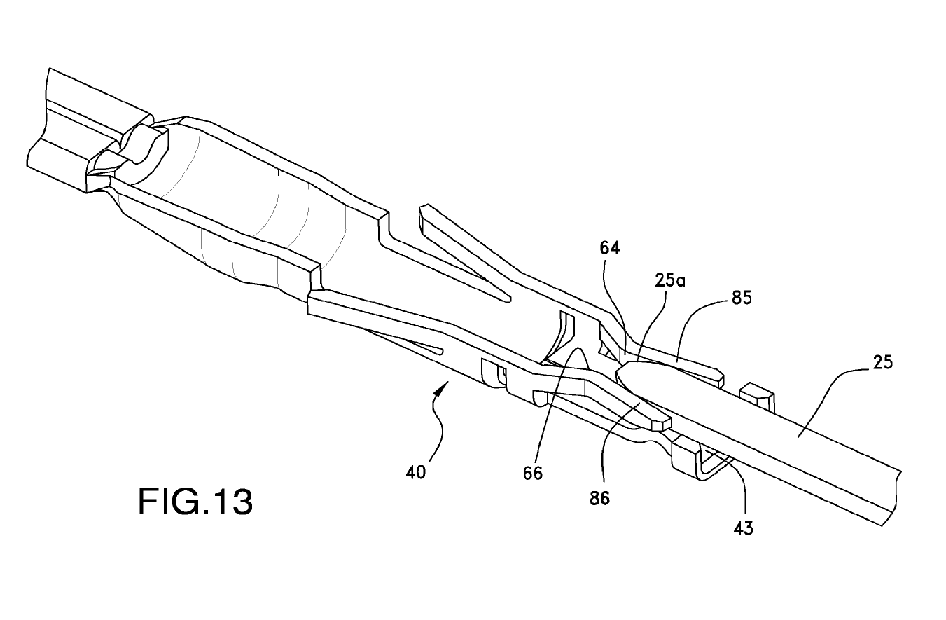

FIG. 13 illustrates the condition in which the male terminal 25 is further inserted into the passageway 43, such that sidewalls of male terminal 25 now engage the arc discharge contacts 85 and 86. The deflection portions 90 and 92 of the opposed channel sidewalls 81 and 82 which define the passageway 43 are resilient and permit the wedge shaped end 25a of the male pin 25 to flex the channel sidewalls 81 and 82 apart as the male pin initially engages the arc discharging contacts 85 and 86.

Upon further insertion of male pin 25 the wedge shaped end 25a contacts the contact portions 64 and 66 of primary contacts 60 and 62. At this time, both the male pin and female terminal are at the same voltage potential eliminating arcing between the male pin and female terminal and therefore no buildup of non-conducting residue, providing positive electrical connection therebetween.

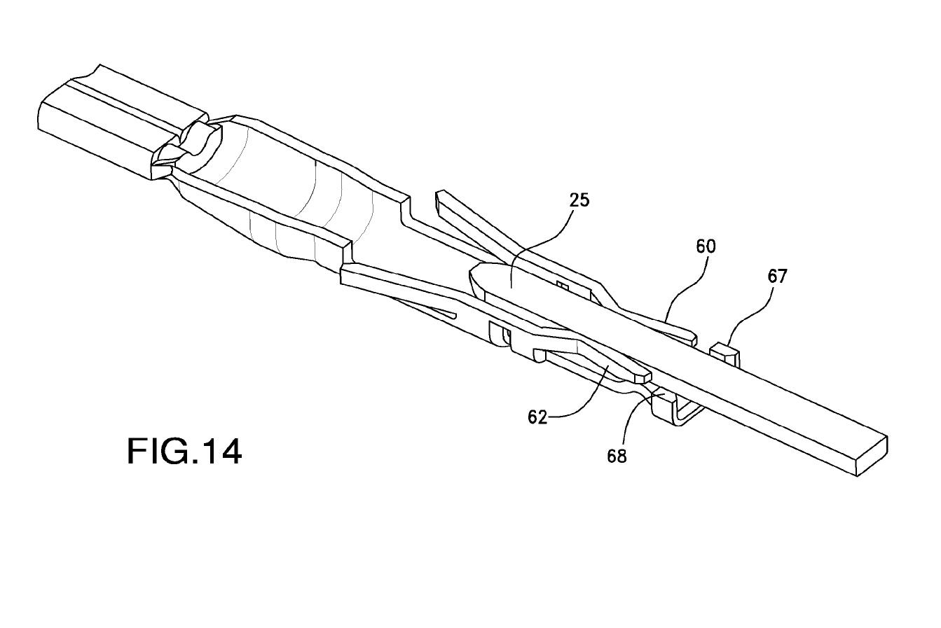

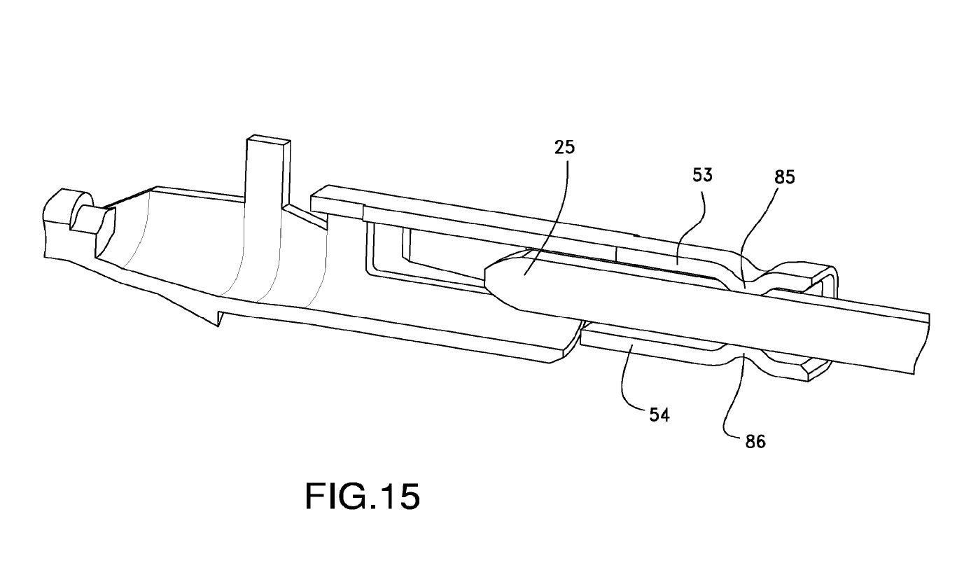

FIGS. 14 and 15 illustrate the complete insertion of male pin 25 into passageway 43. The arc discharging contacts 85 and 86 are formed closer to passageway 43 of the mating portion 42 of the female terminal 40 than the primary contacts 60 and 62. The primary contacts 60 and 62 are positioned behind the arc discharging contacts 85 and 86 so that upon insertion of the male pin 25, electrical contact is first made between the male pin 25 and the arc discharging contacts 85 and 86. The resiliency of deflection portions 90 and 92 of the opposed channel sidewalls 81 and 82 holds and biases the arc discharging contacts 85 and 86 against the male pin 25 by applying normal forces thereto and maintain electrical contact between the male pin and female terminal while not imparting and separation forces between the male pin and the primary contact 60 and 62. Upon further insertion, the male pin 25 subsequently engages the primary contacts 60 and 62 while still engaging the arc discharging contacts 85 and 86. This ensures that an improved electrical contact will exist between the male pin and the primary contacts 60 and 62 of the female terminal 40.

Typically, the prior art disclose the primary contacts positioned at the base of the beam member and the arc discharging contacts are positioned further from the base of the beam member. The closer to the base of a beam that beam deflection occurs the greater the reaction force. Since the arc discharging contact are on the same beam member and positioned further away from the base, the primary contacts essentially lift the arc discharging contact off of the male pin therefore minimizing the electrical force between the arc discharging contacts and the male pin. The further from the base of the beam member that the deflections occurs the lesser the reaction force.

Similarly, in this case, the arc discharging contacts 85 and 86 engage the male pin 25 first and subsequently the primary contacts 60 and 62. Primary contacts 60 and 62 and arc discharging contacts 85 and 86 are not formed on the same beam member but on adjacent members or sidewalls and the resulting reaction force act on different planes. In this case the reaction forces are normal to each other and therefore are independent of each other. In other words, the reaction forces of the primary contacts do not lift the arc discharging contacts off of the male pin.

It is to be understood that such terms as “top”, “bottom”, “front”, “back” or the like, as used herein and in the claims hereof, are used as relative terms only in order to provide a more clear and concise understanding of the invention. Such terms are not to be construed as limiting, because the terminals of the present invention may be oriented in many different directions in actual use, as is well known to persons skilled in the art.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

1. A female terminal, comprising:
a terminal body with a mating end and a circuit connecting end;
a passageway defined in the mating end, the passageway including two sidewalls that are spaced apart and extend lengthwise along the passageway, each of the sidewalls further including two opposed channel sidewalls extending from the sidewalls;
a primary contact disposed along one of the sidewalls and configured to engage, in operation, a flat surface of a corresponding male terminal when the male terminal is inserted into the passageway; and
an arc discharging contact disposed along one of the channel sidewalls forward of the primary contact, the arc discharging contact extending inwardly, such that the male terminal, in operation, comes into contact with the arc discharging contact before coming into contact with the primary contact as the male terminal is inserted into the terminal receiving passageway, whereby any arc discharge between the male and female terminals occurs at the arc discharging contact.

2. The female terminal of claim 1, wherein the passageway is rectangular.

3. The female terminal of claim 1, wherein the primary contact is formed on each sidewall.

4. The female terminal of claim 1, wherein the arc discharging contact is formed on two adjacent channel sidewalls that each extend from one of the two sidewalls.

5. The female terminal of claim 4, wherein each channel sidewall has a cantilever portion extending from one of the two sidewalls.

6. The female terminal of claim 5, wherein the arc discharging contact is formed on the cantilever portion.

7. The female terminal of claim 1, wherein a projection is formed on the intermediate portion of the female terminal.

8. The female terminal of claim 7, wherein the projection is configured, in operation, to come into contact with shoulders formed in the housing upon the insertion of the female terminal into the housing.

9. A connector, comprising:
a terminal as defined in claim 1; and
an insulative housing generally surrounding at least a portion of the terminal.
